(19) United States
(12) Patent Application Publication
(10) Pub. No.: US 2006/0250068 A1
(43) Pub. Date: Nov. 9, 2006

(54) Focusing lens structure for a cathode ray tube electron gun

(76) Inventors: Michel Lefort, Varanges (FR); Bruno Klinguer, Dijon (FR)

Correspondence Address: THOMSON LICENSING INC., PATENT OPERATIONS, PO BOX 5312, PRINCETON, NJ, 08543-5312, US

(21) Appl. No.: 11/415,237

(22) Filed: May 1, 2006

(30) Foreign Application Priority Data
May 3, 2005 (FR) 0551165

(51) Int. Cl. H01J 29/50

(52) U.S. Cl. 313/414

(57) ABSTRACT

Electron gun for colour cathode ray tube comprising two successive electrodes to form a focusing lens, both electrodes each comprising three in-line apertures. The extremity of the electrode brought to the focusing voltage comprises a plate, drilled with in-line apertures. This plate is folded in such a manner that the lateral apertures are arranged in a plane different from the plane of the central aperture. The extremity edge of the electrode comprises an internal peripheral lip that extends according to a longitudinal direction Z, following a width at the level of the central aperture different from its width at the level of the lateral apertures. This structure enables the two main functions of a focusing lens to be controlled independently: the difference in focusing between the lateral beams and the central beam the difference in astigmatism of the central beam with respect to the lateral beams.

The present invention relates to an electron gun for cathode ray tube and more particularly to the structure of an electron gun for colour tube designed to be incorporated into a cathode ray tube with a noticeably flat front face.

### BACKGROUND OF THE INVENTION

A cathode ray tube designed to generate colour images generally includes an electron gun emitting three electron beams, each beam being designed to excite luminescent materials of a primary colour (red, green and blue) on the screen of the tube.

The electron beams sweep over the screen of the tube under the influence of the deflection fields created by a deflection device still called a deviator, fixed on the collar of the tube, comprising the horizontal and vertical deflection coils of the said beams. A ring of a noticeably tapered form in a ferromagnetic material, surrounds the deflection coils in a conventional manner so as to concentrate the deflection fields in the appropriate area.

An electron gun for a colour tube is constituted on the one hand by three cathodes, the surface of which emits electrons and, on the other hand, by a series of electrodes and for which at least one of the electrodes constitutes a focusing lens with the following electrode.

The electrodes are drilled with holes to enable the electron beams from the cathode to pass and form electrostatic lenses having the effect of shaping the beams, accelerating them and focusing them onto the screen of the tube. The impact of the electron beam forms a luminous mark on the screen, still called a spot, due to the excitation of the luminescent materials.

More particularly in the case of the three in-line gun tubes called auto-convergent, the three electron beams converge on the same point on the screen owing to the astigmatism of the horizontal and vertical deflection magnetic fields. The astigmatism of the deflection fields has the effect of deforming the electron beam and consequently deforming the spot. To offset this effect, is its customary to introduce at least one astigmatic electrostatic lens in the region of formation of the electron beam.

Moreover, in the case of in-line beams, owing to the unitary structure of the electrodes, the electrical focusing fields are different between the lateral beams and the central beams; this focusing differential increases with the beam current and can lead to a strong degradation in the resolution of the final image. This focusing differential is generally partially corrected by a reduction in the diameter of the central aperture with respect to the lateral apertures.

However, the current trend is to make the visible surface of the front face of the tube as flat as possible; this requirement induces fields with an astigmatism that is even more complex and more difficult to offset by the structure of the focusing electrodes.

The invention is related to a main focusing lens structure for an electron gun with three in-line beams, used among other things to facilitate the assembly of the gun and to adjust the two main functions of the said terminal independently:
the difference in focusing between the lateral beams and the central beam
the difference in astigmatism to apply to the central beam with respect to the lateral beams.

### SUMMARY OF THE INVENTION

For this, the electric gun for a colour cathode ray tube according to the invention, includes:
three emitting cathodes and a succession of electrodes arranged according to a longitudinal axis Z intended to form and accelerate three in-line electronic beams,
two successive electrodes each comprising three in-line apertures, a central aperture and two lateral apertures, these two electrodes forming a focusing lens,
at least one of the electrodes of the focusing lens comprising a plate drilled with three in-line apertures, the said plate being arranged offset from the edge of the said electrode located as close as possible to the second electrode of the said focusing lens, the said edge also comprising an internal peripheral lip extending in the longitudinal direction,

characterized in that said at least one of the electrodes of the focusing lens is such that the plate drilled with three apertures is folded in such a manner that the lateral apertures are arranged in a different plane from the plane of the central aperture.

### BRIEF DESCRIPTION OF THE DRAWINGS

The invention and its different advantages will be better understood from the following description and drawings, wherein:

FIG. 1 is a section view according to a horizontal plane containing the longitudinal axis of a cathode ray tube incorporating the present invention

FIG. 2 is a partially exploded profile view of an electron gun according to the prior art.

FIG. 3 shows a cross-section view of the structure of the parts facing the electrodes constituting the main focusing lens.

FIG. 4 shows a perspective view of the plate drilled with in-line apertures constituting one part of the present invention.

FIG. 5 shows a perspective view of the focusing electrode according to the present invention

FIG. 6 shows a cross-section of the same electrode according to a plane containing the longitudinal axis and the centres of the in-line apertures of the focusing electrode.

FIGS. 7A and 7B show by cross-section views at the level of a lateral aperture, according to the planes parallel to the longitudinal axis and perpendicular to the alignment direction of the apertures of the focusing electrode, the modifications of the equipotential lines engendered by the electrode structure according to the invention.

FIG. 8 shows an alternative embodiment of the present invention.

### DETAILED DESCRIPTION OF PREFERRED EMBODIMENT

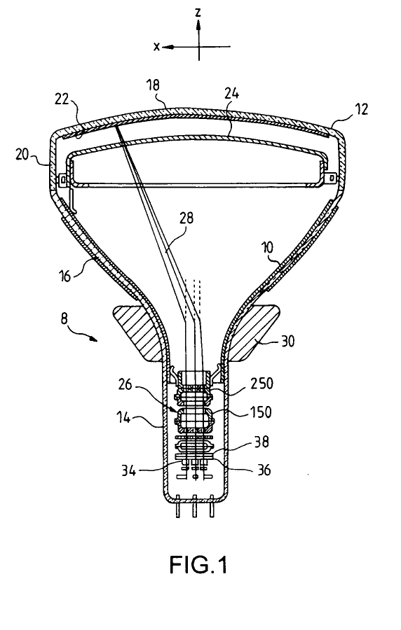

FIG. 1 shows a cross-section view according to a horizontal plane containing the longitudinal axis Z a cathode ray tube 8. This tube is composed of a glass envelope 10, comprising a rectangular front panel 12, a rear part 16 in the form of a funnel and a cylindrical collar 14 containing an electron gun 26 according to the invention. The panel 12 comprises a front face 18 and a peripheral flange 20 linking the front face to the funnel shaped rear part 16. A screen 22 composed of luminophore materials is laid on the internal surface of the front face 18. The screen is preferentially composed of successive lines destined to reproduce the three primary colours red, green and blue. A selection mask of 24 colours is conventionally placed at a predetermined distance from the luminescent screen. The electron gun 26 emits three coplanar electronic beams passing through the openings of the mask 24 to illuminate the networks of luminophore lines composing the screen 22.

The tube 8 is designed for use with a magnetic device for deflecting the electronic beams, the said deflection device being arranged on the collar of the tube in proximity to the electronic gun 26. When it is operating, the deflection device 30 subjects the three electronic beams of the gun 26 to magnetic fields in such a manner that the beams scan the rectangular surface of the screen 22.

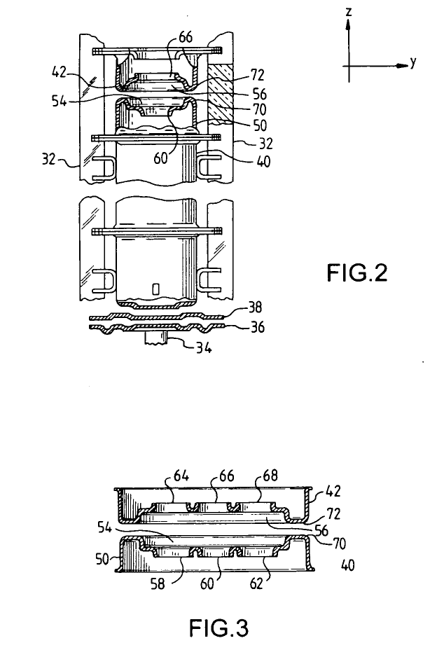

The FIGS. 2 and 3 show in detail an electron gun according to the prior art, as described for example in the American patent U.S. Pat. No. 4,583,024. The gun comprises two glass beads 32 whose function is to support the different electrodes of the electron gun. The gun comprises successively three in-line cathodes 34, a control electrode 36 (G1), a screen electrode 38 (G2), a succession of electrodes not shown, a first focusing electrode 40 (G3) and a second focusing electrode 42 (G4) for example brought to the anode potential. Each electrode is drilled with in-line apertures arranged in planes perpendicular to the longitudinal axis to enable the passage of three in-line electronic beams.

The extremities G3 and G4 facing each other define the main focusing electronic lens; these extremities possess deep recesses, respectively 54 for G3 and 56 for G4, separated from the extremities by an internal peripheral lip (respectively 70 and 72). This internal peripheral lip has a constant longitudinal length according to the longitudinal axis of the gun and the in-line apertures 58, 60, 62 for G3 and 64, 66, 68 for G4 are in a plane arranged at a distance from the extremity of the electrode equal to the longitudinal width of said lip.

Within the framework of the invention, according to one of the preferential embodiments, the decoupling between the two functions of the focusing lens is obtained by arranging the lateral apertures of at least one electrode constituting the focusing lens in a plane different from the plane containing the central aperture.

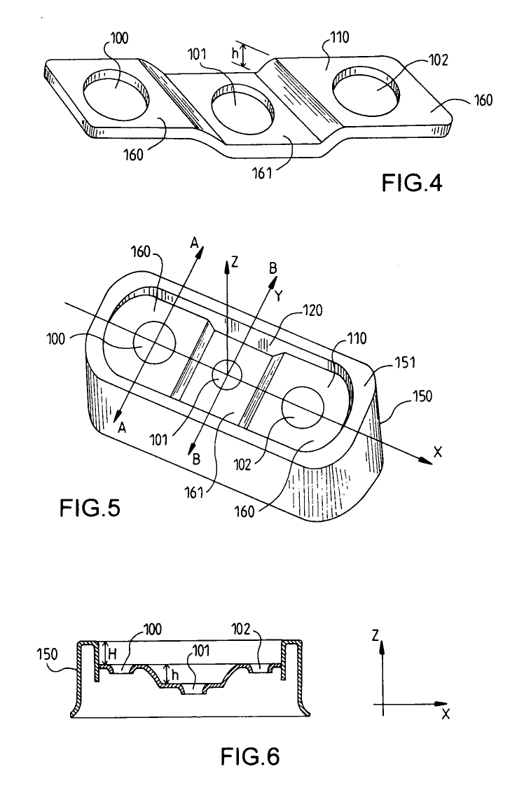

FIGS. 4 to 7 describe this embodiment in detail.

The gun according to the invention comprises in a known manner a succession of electrodes to extract the electronic beams from the cathodes, form them, accelerate them and focus them; the last two electrodes 150 and 250 whose extremities produce the focusing lens are the one brought to the potential called focusing and the other brought to a higher potential, for example to the anode high voltage. According to the invention, the extremity of the electrode brought to the focusing voltage comprises a plate 110, drilled with in-line apertures 100, 101, 102. This plate is folded in such a manner that the lateral apertures 100, 102 are arranged in a plane different from the plane of the central aperture. As shown in FIG. 4, the plane of the central aperture 161 is arranged toward the inside of the electrode, at a distance “h” from the plane 160 of the lateral apertures, this plane 160 being situated according to the longitudinal direction at a distance H from the extremity 151 of the electrode 150, extremity located opposite the electrode 250 brought to the anode potential; the plate 110 is arranged within the electrode and held in place for example by laser welding on the longitudinal sides of the electrode 150; it is thus possible to adjust the focal point of the main lens identically for the three apertures by varying the position of the plate 110 and thus the value H; it is also possible to vary the focal length differently for the lateral beams and for the central beam by varying the value of the distance h of the planes 160 and 161.

Thus for a plate 110 for which the centres of the apertures 100, 101, 102 are at a distance of 6.2 mm from an electrode 150 brought to a potential in the order of 8 kV and anode potential in the order of 30 kV, it is possible to compensate partially for the focusing differential by using a central aperture of diameter 4.06 mm and lateral apertures of diameter 4.57 mm. However it is not possible to compensate fully for the several 200 volts of residual focusing differential by this method as the diameter of the central aperture must remain at a minimum value and the total dimensions are limited by the diameter of the tube collar in which the gun is inserted, which limits the diameter of the lateral apertures.

The residual focusing differential in the order of 200 volts is then compensated for by offsetting the aperture planes as indicated in FIG. 4, by a value h in the order of 0.38 mm.

The invention can also be applied to correct the entire focusing differential that may appear in a structure in which the apertures are all the same diameter, by adapting the amplitude of the offset h to the differential to correct. This configuration enables a maximum diameter of the central aperture to be obtained which presents the advantage of preventing beam interception problems, particularly at high current, when the aperture diameter is low.

The electrode structure according to the invention also enables the astigmatism of the electric field acting on the beams to be modified and this in a different manner on the lateral beams and on the central beam.

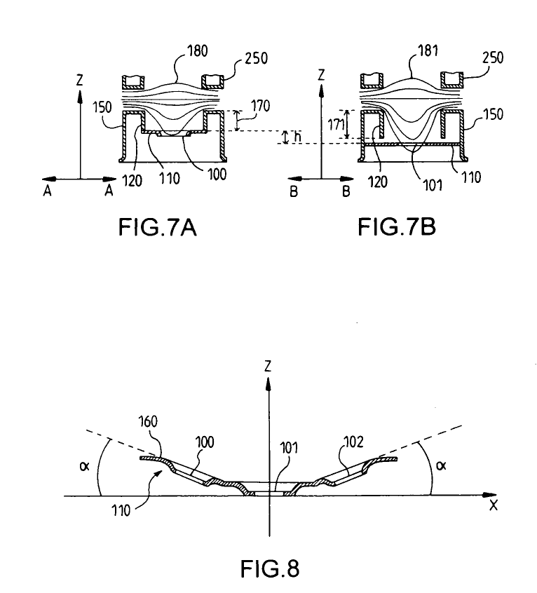

For this, as illustrated by the embodiment of FIGS. 5, 7A, 7B, the internal peripheral lip 120 extends according to the longitudinal direction Z, according to a width 171 at the level of the central aperture different from its width 170 at the level of the lateral openings.

The focusing lens seen thus presents a force in the direction Y, perpendicular to the alignment direction X of the three apertures, that is greater for the central electronic beam than for the lateral beams. This difference in force is due to the modification of the distribution of the equipotential lines in the vertical direction Y due to the larger width of the internal peripheral lip in the longitudinal Z direction. This modification is illustrated by FIGS. 7A and 7B where the equipotential lines respectively 180 according to the AA cross-section (plane parallel to the ZY plane at the level of a lateral aperture) and 181 according to the cross-section BB (plane ZY at the level of the central aperture) are shown.

The astigmatism introduced by the lip structure 120 depends on the corrections to be applied to compensate for the astigmatisms introduced either by the different stages of the electron gun or by the deflection fields of the deflection system 30. The result is that the longitudinal width of the internal lip 120, as in the embodiment illustrated by the FIGS. 7A and 7B, can be greater at the level of the central aperture than at the level of the lateral apertures but that it can also be lower at the level of the central aperture according to the type and amplitude of astigmatism to compensate.

In an alternative embodiment, the drilled plate of three apertures 110 is folded not only in such a manner that the plane containing the central aperture is distinct from the plane containing the lateral apertures, but the lateral apertures are also contained in the different planes. FIG. 8 illustrates this embodiment in which the lateral apertures are arranged in planes making a non-null angle a with the plane of the central apertures. This structure presents the additional advantage of acting on the convergence of the electronic beams owing to the inclination of the lateral apertures with respect to the longitudinal axis of the gun.

In an embodiment not shown, the structure according to the invention enabling the correction of astigmatism and the focusing differential can also be arranged on the electrode brought to the anode potential rather than on the focusing electrode. Alternatively, the structure according to the invention enabling the correction of astigmatism and the focusing differential can be distributed advantageously over the parts facing the electrodes 150, 250 forming the focusing lens by ensuring that these parts each incorporate a structure according to the invention, with a plate drilled with three apertures, folded such that the plane containing the central aperture is separate from the plane(s) containing the lateral apertures. This arrangement presents many advantages, among which are possibly obtaining identical electrode parts favouring the assembly of the gun by not having to differentiate the two parts, the stock management for the parts of the gun by reducing the number of parts to manage and the reduction in the number of manufacturing tools of the said parts.

What is claimed is:

1/ Electric gun for colour cathode ray tube, comprising three emitting cathodes and a succession of electrodes arranged according to a longitudinal axis Z and designed to form and accelerate three in-line electronic beams, among which are two successive electrodes each comprising three in-line apertures, one central aperture and two lateral apertures, these two electrodes forming a focusing lens, at least one of the electrodes of the focusing lens comprising a plate drilled with three apertures arranged offset from the extreme edge of the said electrode situated as close as possible to the second electrode of the said lens, said edge also comprising an peripheral lip whose internal part extends in the longitudinal direction,
wherein said at least one of the electrodes of the focusing lens is such that the plate drilled with three apertures is folded such that the plane containing the central aperture is separate from the plane(s) containing the lateral apertures

2/ Gun according to claim 1, wherein the central aperture and the lateral apertures are contained in parallel planes

3/ Gun according to claim 1, wherein the width of the internal lip measured at the level of the central aperture is different from the width measured at the level of the lateral apertures.

4/ Gun according to claim 3, wherein the internal peripheral lip is wider at the level of the central aperture than at the level of the lateral apertures

5/ Gun according to claim 1, wherein the plate drilled with three apertures is folded such that the lateral apertures are arranged in the same plane further from the extreme edge than the plane containing the central aperture

6/ Gun according to claim 1, wherein said at least one of the electrodes of the focusing lens is the electrode located closest to the cathodes.

7/ Electronic gun according to claim 1, wherein the two electrodes of the focusing lens are such that they both comprise a plate drilled with three apertures folded such that the plane containing the central aperture is separate from the plane(s) containing the lateral apertures.

8/ Cathode ray tube with a flat face, wherein it incorporates an electron gun compliant with claim 1.
